(19) United States
(12) Patent Application Publication
(10) Pub. No.: US 2026/0072299 A1
(43) Pub. Date: Mar. 12, 2026

(54) INORGANIC BROADBAND PLASMONIC MODULATOR

(71) Applicants: HUAWEI TECHNOLOGIES CANADA CO., LTD., Kanata (CA); THE UNIVERSITY OF OTTAWA, Ottawa (CA)

(72) Inventors: Masoud SHABANI NEZHAD NAVROOD, Ottawa (CA); Pierre Simon Joseph BERINI, Ottawa (CA); Hamid MEHRVAR, Kanata (CA); Lora RAMUNNO, Ottawa (CA); Eric BERNIER, Kanata (CA)

(73) Assignees: HUAWEI TECHNOLOGIES CANADA CO., LTD., Kanata (CA); THE UNIVERSITY OF OTTAWA, Ottawa (CA)

(21) Appl. No.: 18/982,714

(22) Filed: Dec. 16, 2024

Related U.S. Application Data
(60) Provisional application No. 63/692,482, filed on Sep. 9, 2024.

(51) Int. Cl. G02F 1/01

(52) U.S. Cl. CPC G02F 1/0113; G02F 2201/06; G02F 2203/10

(57) ABSTRACT

A method and apparatus for modulation of an optical signal are provided. The optical signal is transmitted by an optical waveguide that has disposed at least partially thereon two stack assemblies that include a gap above and longitudinally aligned with the optical waveguide. Each stack assembly includes a bottom anode layer (e.g., Al), an insulating coating disposed on the bottom anode layer (e.g., Al₂O₃), at least one inorganic modulation material (e.g., ITO) layers disposed on the insulating coating, and a cathode layer disposed on top of the at least one inorganic modulation material layers. The optical signal transmitted by the optical waveguide can be modulated in accordance with an electrical signal (e.g., voltage) applied to both stack assemblies. Tapered portions are provided for coupling the optical signal from the waveguide to the stack assemblies, and from the stack assemblies to the waveguide.

### CROSS-REFERENCE TO RELATED APPLICATIONS

This application claims priority to U.S. Provisional Patent Application No. 63/692,482, filed Sep. 9, 2024 and entitled “Inorganic Broadband Plasmonic Modulator,” the entire contents of which are incorporated herein by reference.

### FIELD OF THE INVENTION

The present disclosure pertains to the field of optical signal communication, and in particular to an optical modulation apparatus.

### BACKGROUND

Rapidly-growing traffic in data centers (e.g. pertaining to Internet of Things, big data, 3^{rd} Generation Partnership Project (3GPP) 5^{th} generation (5G) networks, self-driving cars, etc.) highlights the need for high-speed, low-cost and more efficient interconnects (e.g., optical interfaces, electro-optical interfaces, from 400 G to 800 G (Gb/second) to 1.6 T to 3.2 T (Tb/second) transmission links for datacenter and computing. As such, an 800 G Ethernet working group has been formed to tackle standardization and specification for these interfaces. It is expected that 800 G transceivers may become most popular modules in mega data centers by 2025. To deliver 800 G and 1.6 T (and beyond) for Datacenter/cloud computing/HPC/Mega-datacenters, a modulator bandwidth needs to be high, e.g., 200 G or higher for each lane that operates in a set of wavelengths used for multi-lane transceiver. In addition to Datacenter (DC) and computing applications, high bandwidth modulators for optical networks allow higher rate transceivers for metro and transponders for long-haul connectivity among the nodes of the optical networks that interconnects datacenters, cloud computing centers, and optical switches. To satisfy the demands, electro-optic modulators should feature large bandwidths, and operate across all telecommunication bands (1310 nm for datacenters and 1550 nm for optical networks), offer a small footprint, and allow for CMOS-compatible fabrication to keep the costs low.

In addition to high bandwidth requirement, compactness and reliability are two other desirable features for successful deployment of next generation modulators. Unlike electronic devices in which the number of transistors in a fixed area of integrated circuits almost doubles every year that allows compactness for the electronic devices, the same cannot be said for optical waveguides. This is because optical waveguides cannot be compacted below half of propagation wavelength due to the diffraction limit. This hinders integration of optical waveguides with electronic devices. As a result of this limitation, in recent years some researchers have explored the possibility of plasmonic waveguides. Use of plasmonic waveguide in design of next generation modulators may allow co-integration with electronic systems as well as compact designs for ultra-fast operation. Plasmonic modulator structures allow light confinement beyond the diffraction limit, thus allowing compact modulators of footprint potentially of only a few μm². They may offer additional advantages such as small capacitances and resistances, and consequently, small associated resistor-capacitor (RC) time constants which enable lumped-element operation over extremely high electrical bandwidths.

Some existing ITO (Indium Tin Oxide) modulator designs have been proposed based on plasmonic structures. For instance, a hybrid plasmonic waveguide (HPW) configuration was used to manage the confinement-attenuation trade-off, implemented as a Metal Oxide Semiconductor (MOS) structure. A design based on coupled hybrid plasmonic waveguides (CHPW) has also been proposed for modulator applications, as another approach to manage the confinement-attenuation trade-off. These designs use direct butt coupling from an input silicon waveguide, and do not include mode transformation sections to optimize coupling to the HPW mode. Due to mode mismatch, direct butt coupling from the input silicon waveguide may result in power coupling to other forward propagating modes such that the power output depends on the interference between the excited modes of the HPW modulator section. Also, this configuration gives rise to additional semiconductor resistance in the cathode contacts, which in turn limit the electrical bandwidth of the design.

Researchers have also demonstrated that Plasmonic Organic Hybrid (POH) and Silicon Organic Hybrid (SOH) based on organic materials can offer both compact and high-speed modulators. However, the result of this research could not be reduced to practice as organic materials suffer from reliability and longevity issues.

Therefore, there is a need for apparatuses and methods for broadband modulation that obviates or mitigates one or more limitations of the prior art.

This background information is provided to reveal information believed by the applicant to be of possible relevance to the present disclosure. No admission is necessarily intended, nor should be construed, that any of the preceding information constitutes prior art against the present disclosure.

### SUMMARY

One or more aspects of disclosure provides for systems and methods for broadband modulation, including an optical component.

According to embodiments, there is provided an optical modulation apparatus. The apparatus includes an optical waveguide disposed in a substrate and configured for guiding an optical signal, a first stack assembly, and a second stack assembly. A top surface of the optical waveguide is at least in part in a same horizontal plane as a top surface of the substrate. The optical waveguide has a longitudinally linear section. The first stack assembly is longitudinally disposed on the top surface of the substrate and is at least partially on the top surface of the longitudinally linear section of the optical waveguide. The second stack assembly is longitudinally disposed on the top surface of the substrate and is at least partially on the top surface of the longitudinally linear section of the optical waveguide. The first and the second stack assemblies are separated by a gap above and longitudinally aligned with the optical waveguide. Each stack assembly of the first and the second stack assemblies includes: an anode layer; an insulating coating disposed on top of the anode layer; at least one inorganic modulation material layers disposed on the insulating coating; and a cathode layer disposed on top of the at least one inorganic modulation material layers.

According to some embodiments, the first and the second stack assemblies cooperatively comprise: a central region defined at least in part by a narrowest region of the gap; a first tapered portion integral with the central region and defined by opposing inner walls of the first and the second stack assemblies converging asymptotically along the longitudinal direction towards the central region; and a second tapered portion integral with the central region and defined by the opposing inner walls of the first and the second stack assemblies diverging along the longitudinal direction away from the central region.

According to some embodiments, the anode layer is made of aluminum.

According to some embodiments, the insulating coating is made of aluminum oxide.

According to some embodiments, each inorganic modulation material layer of the at least one inorganic modulation material layers is made of a respective ternary composition of indium, tin and oxygen.

According to some embodiments, the gap extends into the optical waveguide and the substrate below the horizontal plane by a predefined depth.

According to some embodiments, the apparatus is configured for propagation of at least one target mode of the optical signal, the optical waveguide comprises a bent section having at least one S-shaped bend, the bent section longitudinally integral with and following the linear section of the optical waveguide, the bent section configured to limit propagation of a one or more mode other than the at least one target mode of the optical signal.

According to some embodiments, the first tapered portion and the second tapered portion are linearly tapered at an acute angle in the range of about 2 degrees to about 5 degrees.

According to some embodiments, the first and the second stack assemblies have a substantially same width.

According to some embodiments, the insulating coating is disposed on a top surface and an external surface of the anode layer.

According to some embodiments, the at least one inorganic modulation material layers are disposed on a top surface and an external surface of the insulating coating.

According to some embodiments, the at least one inorganic modulation material layers are further disposed on at least a portion of the top surface of the substrate adjacent the at least one inorganic modulation material layers disposed on the external surface of the insulating coating.

According to some embodiments, the cathode layer is disposed on a top surface and at least partially on an external surface of the at least one inorganic modulation material layers.

According to some embodiments, the narrowest region of the gap has a width in the range of about 200 nm to about and 500 nm.

According to some embodiments, an input end of the first tapered portion of the gap has a width in the range of about 400 nm to about 1000 nm and an output end of the second tapered portion of the gap has a width in the range of about 400 nm to about 1000 nm.

According to some embodiments, the apparatus is operable by receiving the optical signal at the optical waveguide and applying a voltage in the range of about 1.6V to about 2.8V to the anode layer.

According to some embodiments, the apparatus is configured to modulate the optical signal having a wavelength between about 850 nm and about 1550 nm.

According to embodiments, there is provided an optical transceiver or optical transmitter comprising the apparatus as described above.

According to embodiments, there is provided a method. The method includes receiving an optical signal at an optical waveguide disposed in a substrate and configured for guiding the optical signal. A top surface of the optical waveguide is at least in part in a same plane as a top surface of the substrate, and the optical waveguide has a longitudinally linear section. The method includes applying an electrical signal to a first stack assembly and a second stack assembly. The first stack assembly is longitudinally disposed on the top surface of the substrate and at least partially on the top surface of the longitudinally linear section of the optical waveguide. The second stack assembly is longitudinally disposed on the top surface of the substrate and at least partially on the top surface of the longitudinally linear section of the optical waveguide, the first and the second stack assemblies being separated by a gap above and longitudinally aligned with the optical waveguide. Each stack assembly of the first and the second stack assemblies includes: an anode layer; an insulating coating disposed on top of the anode layer; at least one inorganic modulation material layers disposed on the insulating coating; and a cathode layer disposed on top of the at least one inorganic modulation material layers.

In some embodiments, the method includes obtaining a modulated optical signal modulated in accordance with the electrical signal.

Embodiments have been described above in conjunction with aspects of the present disclosure upon which they can be implemented. Those skilled in the art will appreciate that embodiments may be implemented in conjunction with the aspect with which they are described but may also be implemented with other embodiments of that aspect. When embodiments are mutually exclusive, or are incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present disclosure will become apparent from the following detailed description, taken in combination with the appended drawings, in which:

FIG. 1 shows a schematic illustration of a perspective view of an optical modulation device, according to the prior art.

FIG. 2A shows a schematic illustration of a perspective view of an optical modulation apparatus, according to an embodiment of the present disclosure.

FIG. 2B shows a schematic illustration of a top view of the optical modulation apparatus of FIG. 2A, according to an embodiment of the present disclosure.

FIG. 3A shows another schematic illustration of a perspective view of an optical modulation apparatus, according to an embodiment of the present disclosure.

FIG. 3B shows a schematic illustration of a cross section of the optical modulation apparatus of FIG. 3A, according to an embodiment of the present disclosure.

FIG. 4 shows a schematic illustration of a cross section of an optical modulation apparatus, according to an embodiment of the present disclosure.

FIG. 5 shows a schematic illustration of a cross section of an optical modulation apparatus, according to another embodiment of the present disclosure.

FIG. 6A shows a schematic illustration of layers of a stack assembly of an optical modulation apparatus, according to an embodiment of the present disclosure.

FIG. 6B shows a schematic illustration of a carrier density profile within ITO versus a distance from the oxide-ITO interface at various gate voltages, obtained using the CDD model, according to an embodiment of the present disclosure.

FIG. 6C shows a schematic illustration of a carrier density profile within ITO versus the distance from the oxide-ITO interface at various gate voltages, obtained using the Schrödinger-Poisson Coupling (SPC) model, according to an embodiment of the present disclosure.

FIG. 7 shows a table detailing selected parameters obtained using modeling for selected example optical modulation apparatuses having respective gap widths of an active region, according to an embodiment of the present disclosure.

FIG. 8 shows modeled field distributions in the optical waveguide, the stack assemblies, and at the output of the second stack assembly for selected voltages, according to an embodiment of the present disclosure.

FIG. 9 shows a schematic illustration of a top view of an optical modulation apparatus having an optical waveguide that includes a bent portion, and a modeled cross-sectional field distributions at an input, before the bent section, and after the bent section, according to an embodiment of the present disclosure.

It will be noted that throughout the appended drawings, like features are identified by like reference numerals.

### DETAILED DESCRIPTION

The present disclosure provides an apparatus and method for optical modulation of an optical signal. The optical signal is transmitted by an optical waveguide that has disposed at least partially thereon two stack assemblies each comprising a Metal Oxide Semiconductor (MOS) structure within a Metal Insulator Metal (MIM) structure (also referred to herein as MOS-MIM stacks). Each stack assembly includes a bottom anode layer (e.g., metal such as Al, Au, Cu, Pt, Ni, other, e.g., composite, conducting materials that can act as an anode), an insulating coating disposed on the bottom anode layer (e.g., an oxide such as Al₂O₃, HfO₂, SiO₂, TiO₂), at least one inorganic modulation material (e.g., semiconductor such as an Ge, GeAs, ZnO, a conductive oxide such Indium Tin Oxide (ITO), Aluminum doped Zinc Oxide (AZO), Gallium doped Zinc Oxide (GZO) layers (also referred to herein as an inorganic layer) disposed on the insulating coating, and a cathode layer (e.g., metal such as Al, Au, Cu, Pt, Ni, other, e.g., composite, conducting materials that can act as a cathode) disposed on top of the at least one inorganic modulation material layers. The modulation materials may be high-index materials. The stack assemblies include a gap above and longitudinally aligned with the optical waveguide. The optical signal transmitted by the optical waveguide can be modulated in accordance with an electrical signal (e.g., voltage) applied to both stack assemblies.

The present disclosure sets forth various embodiments via the use of block diagrams, flowcharts, and examples. Insofar as such block diagrams, flowcharts, and examples contain one or more functions and/or operations, it will be understood by a person skilled in the art that each function and/or operation within such block diagrams, flowcharts, and examples can be implemented, individually or collectively, by a wide range of hardware, software, firmware, or combination thereof. As used herein, the term “about” should be read as including variation from the nominal value, for example, a +/−10% variation from the nominal value. It is to be understood that such a variation is always included in a given value provided herein, whether or not it is specifically referred to. The phrase “in embodiments” can be interpreted to mean “in one or more, but not necessarily all embodiments.”

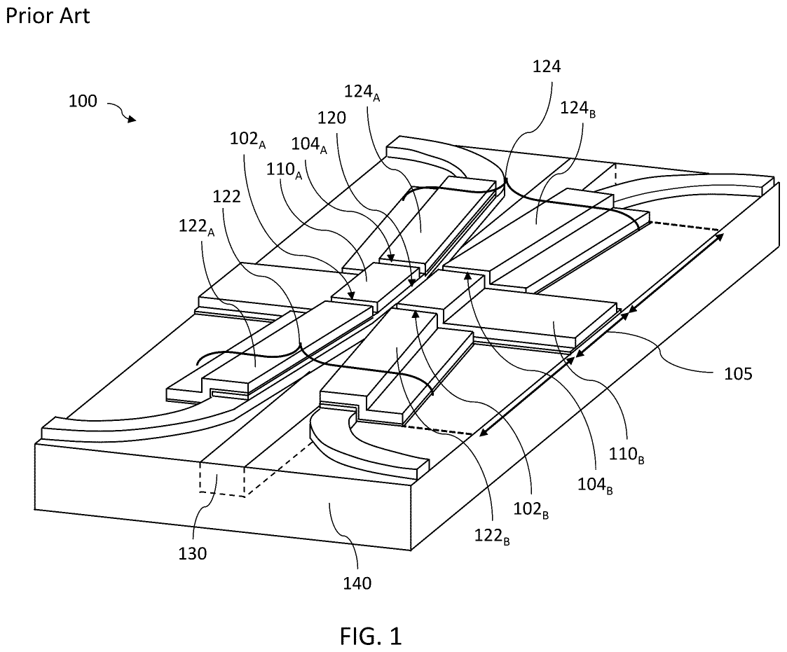

International Patent Application Publication No. WO 2024/150028 describes an optical modulation device having coupled metal-insulator-metal waveguides featuring at least two MOS stacks, with each stack composed of a conductive metal (as anode or cathode), an insulator, an inorganic material and a conductive metal (as cathode or anode). The two MOS stacks are separated by gap g. A primary silicon waveguide or silicon nitrite waveguide resides beneath these two MOS stacks. Gold (Au) is used as conductive metal and Hafnia as an insulator and the inorganic material is ITO films. In this referenced device, shown in FIG. 1, a plasmonic electro-optic modulator utilizes parallel Metal-Insulator-Metal (MIM) stacks that include an active portion that is electro-optically isolated from the input and output tapered sections (e.g., by air slits or insulators) provided to limit capacitance and enhance bandwidth for this particular modulator design.

FIG. 1 is a schematic perspective view of the optical modulation device 100, according to prior art. The device 100 includes a substrate 140 and an optical waveguide 130 therein. The device 100 includes first and second assemblies 110A, 110B, on top of the substrate 140 and the optical waveguide 130, that form an active portion, having a length 105 and having a gap 120, which may operate with coupled plasmonic modes. The optical modulation device 100 further includes extending assemblies 122A and 122B, and 124A and 124B that form two tapered sections 122 and 124, respectively.

The device 100 includes slits 102A, 104A, 102B, and 104B defined between the extending assembly 122A and the assembly 110A of the active portion, between the assembly 110A of the active portion and the extending assembly 124A, between the extending assembly 122B and the assembly 110B of the active portion, and between the assembly 110B of the active portion and the extending assembly 124B, for keeping the extended assemblies 122A and 122B, and 124A and 124B electrically isolated from the assemblies 110A and 110B of the active portion. Assemblies 110A and 110B are made of a bottom cathode layer on top of the substrate and optical waveguide surface, an inorganic semi-conductive material film on top of the cathode layer, an insulating coating on top of the inorganic semi-conductive material film, and an upper anode layer on top of the insulating coating.

Embodiments of the present disclosure pertain to an optical modulator design based on coupled MOS-MIM stacks (also referred to herein as stack assemblies) that feature at least two MOS-MIM stacks (i.e., at least two stack assemblies), wherein each stack includes or is composed of a conductor (as anode or cathode), an insulator, an inorganic material, another conductor (as cathode or anode), separation of the stack assemblies by a gap and the two stack assemblies are on top an optical waveguide.

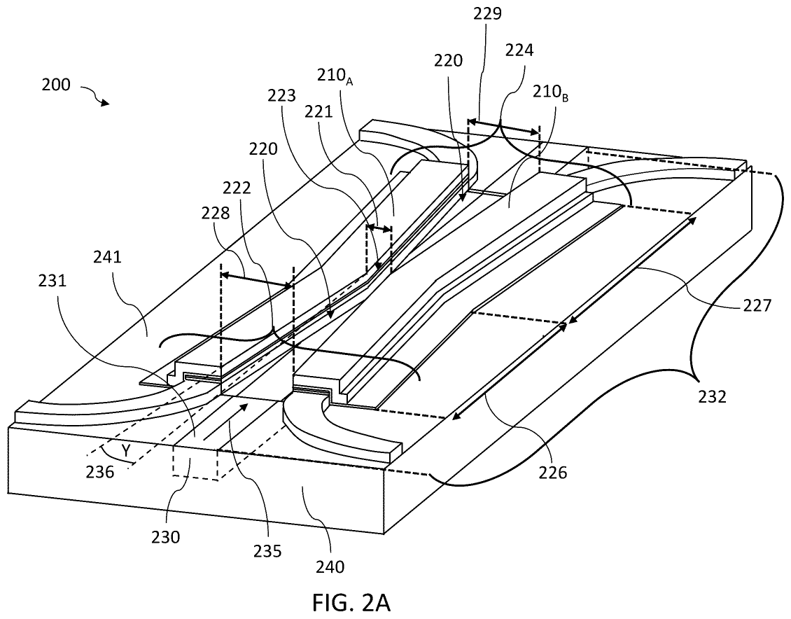

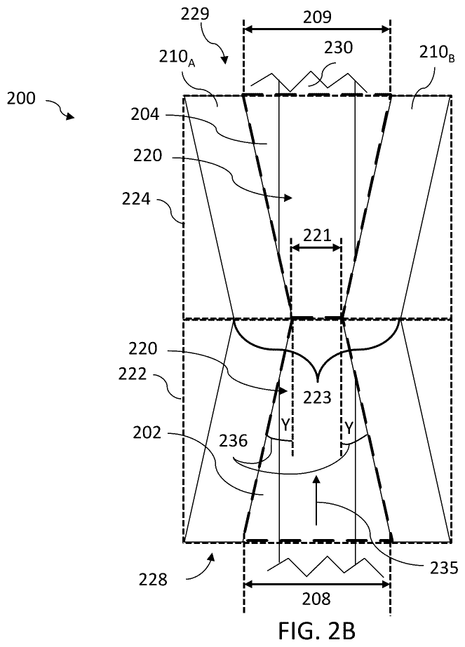

In comparison with the design of FIG. 1, embodiments of the present disclosure provide an optical modulation apparatus (also referred to herein as a modulator) in which the air slits 102A, 102B, 104A, 104B are not present. A modulating region of the apparatus is associated with a central region of the stack assemblies at least in part defined by a narrowest region of the gap between the stack assemblies, and tapered portions of the stack assemblies are integral with the central region. The modulating region of the apparatus includes but is not necessarily limited to the central region. The modulating region may include the central region as well as the entirety of the two tapered portions, or at least parts of the two tapered portions of the stack assemblies. The modulating region, as referred to herein, is generally defined as a region of the stack assemblies where one or more (e.g., target) propagating modes transmitted by the optical waveguide disposed in the substrate couple with or are affected by the stack assemblies. The central region is defined herein as a structural reference and may generally be or include a lateral plane, generally normal to an axial direction of the apparatus (e.g., 235 in FIGS. 2A and 2B), and defined by a plane where a first (converging) tapered portion of the stack assemblies integrally meets a second (diverging) tapered portion of the stack assemblies. The central region may be a slice having a thickness along the axial direction, for example if the integral join of the two tapered portions is gradual, either by design or as a result of fabrication tolerances. The present design is also simplified making it more feasible for practical implementation that enables Complementary Metal-Oxide-Semiconductor (CMOS) compatibility in fabrication. Performance is potentially improved for example by mitigating mode distortion and/or losses caused by the air slits of FIG. 1.

Embodiments of the present disclosure incorporate two mode conversion tapers defined by first tapered portion and second tapered portion of the stack assemblies strategically positioned at least partially on top of an optical (e.g., silicon) waveguide. The apparatus design features various structural and material components which may enhance fabrication feasibility and modulator performance. Embodiments exhibit a streamlined structure that allows uniform voltage application across the entire device.

Embodiments of the present disclosure present a modulator apparatus design which is unitary and simple in structure, making it particularly feasible for practical implementation. For example, rather than having air slits as in FIG. 1, embodiments provide a design in which mode conversion tapers integrally meet at the central region and, at least in part, cooperatively with the central region form the modulating region which is driven to enact modulation. That is, at least portions of the mode conversion tapers, in addition to the central region of the stack assemblies, also operate as the modulating region. Additionally or alternatively, embodiments of the present disclosure are formed using certain materials and exhibit certain structural characteristics which allow CMOS compatibility in fabrication.

Embodiments of the present disclosure provide for a metal such as aluminum (Al) as the bottom electrode. Despite its higher optical absorption compared to gold (Au), aluminum offers fabrication advantages, such as the ease of creating a reliable aluminum oxide (Al₂O₃) insulating layer or coating, which ensures a more uniform insulating layer and reduces the capacitance per unit length of the modulator. The entire bottom Al layer may act as the anode with the voltage source connected, while the top metal (e.g., gold) layer is grounded, creating a simple and effective electrical driving scheme. This type of MIM structure allows the MOS capacitor, formed by the bottom anode layer (e.g., metal), the oxide layer, and the inorganic (e.g., ITO) layer covering the top and sidewalls, to be efficiently driven by applying voltage, enhancing the modulation effect both horizontally and vertically within the inorganic layer.

According to some embodiments, the high-speed plasmonic modulator comprises or consists of an Al—Al₂O₃-ITO stack integrated as a MOS structure within the MIM configuration that cooperatively form the stack assemblies. Applying voltage across the stack assemblies perturbs the carrier density in the ITO layer, significantly impacting the optical properties of the modulator by dynamically altering the complex refractive index of ITO. In contrast to previous approaches, which rely on the Classical Drift Diffusion (CDD) model to simulate the carrier density within the perturbed region of ITO, the assessment of the current design may employ the Schrödinger-Poisson Coupling (SPC) model and compare results obtained with both models. The former is conventionally used in semiconductor simulations, but the latter captures effects due to quantization and is fundamentally more accurate. Embodiments of the present disclosure may include design elements created based at least in part on results from SPC modeling.

According to embodiments, the modulation process commences by launching the fundamental transverse magnetic (TM₀) mode of the (e.g., Si) waveguide toward the modulator. This mode is then adiabatically transferred into the stack assemblies via an input taper (i.e., first tapered portion of the stack assemblies), during which the gap between the stack assemblies, linearly narrows from, for example, 520 nm to a minimum value (gₘᵢₙ) in the middle of modulator. The optical signal is then returned adiabatically to the TM₀ mode of the waveguide through an output taper (i.e., second tapered portion of the stack assemblies), where the gap linearly widens or diverges from the narrowest region of the gap back to, for example 520 nm. This linear adjustment of the gap facilitates efficient mode conversion and limits losses during optical signal transmission, contributing to optimizing the device's overall performance. Driving these back-to-back tapers into accumulation increases the attenuation of the mode, and thus the insertion loss of the tapers, thereby modulating the intensity of the transmitted light.

FIGS. 2A and 2B show a schematic perspective view and a schematic top view, respectively, of the optical modulation apparatus 200, according to an embodiment. The apparatus 200 includes a substrate 240 and an optical waveguide 230 disposed therein. The optical waveguide 230 has a longitudinally linear section 232 and aligned with a first axial direction 235.

The device 200 includes first and second stack assemblies 210_{A}, 210_{B}, respectively, longitudinally disposed on the top surface 241 of the substrate 240 and at least partially on the top surface of the longitudinally linear section 232 of the optical waveguide 230. The first and the second stack assemblies 210_{A}, 210_{B}, are separated by a gap 220 above and longitudinally aligned with the optical waveguide 230. The gap 220 has a variable width along the first axial direction 235 as shown, for example progressively narrowing or converging, in a converging region 202 of the gap 220, toward a narrowest region (which may have substantially zero width) of the gap at a central region 223 of the stack assemblies 210_{A}, 210_{B}, and then progressively widening or diverging again, in a diverging region 204 of the gap 220.

The stack assemblies 210_{A}, 210_{B} have the central region 223 defined at least in part by a narrowest region of the gap, the narrowest region having a width 221 (e.g., 340 nm) of the gap 220.

In embodiments, the narrowest region of the gap may have a predefined width in the range of about 200 nm to about 500 nm. In some embodiments, the predefined width may in the range of about 300 nm to about and 400 nm, e.g., 340 nm.

The stack assemblies 210_{A}, 210_{B} have a first tapered portion 222 integral with the central region 223 and defined by opposing inner walls of the first and the second stack assemblies 210_{A}, 210_{B}, respectively, converging asymptotically along the longitudinal direction 235 towards the central region 223. The stack assemblies 210_{A}, 210_{B} have a second tapered portion 224 integral with the central region 223 and defined by the opposing inner walls of the first and the second stack assemblies 210_{A}, 210_{B}, respectively, diverging along the longitudinal direction 235 away from the central region 223. The first and the second tapered portions 222, 224, have respective lengths 226, 227 (measured in the longitudinal direction 235), and can be linearly tapered at an acute angle Y 236 greater than zero degrees and up to about 15 degrees, for example between about 2 degrees and about 5 degrees, to an axis parallel with the longitudinal direction 235. At an input end 228 of the first tapered portion 222, the gap 220 has a defined a gap width 208 (e.g., 520 nm), and at an output end 229 of the second tapered portion 224 the gap 220 has a defined gap width 208 (e.g., 520 nm).

In embodiments, the input end of the first tapered portion of the gap may have a predefined width in the range of about 400 nm to about 1000 nm. The output end of the second tapered portion of the gap may have a predefined width in the range of about 400 nm to about 1000 nm.

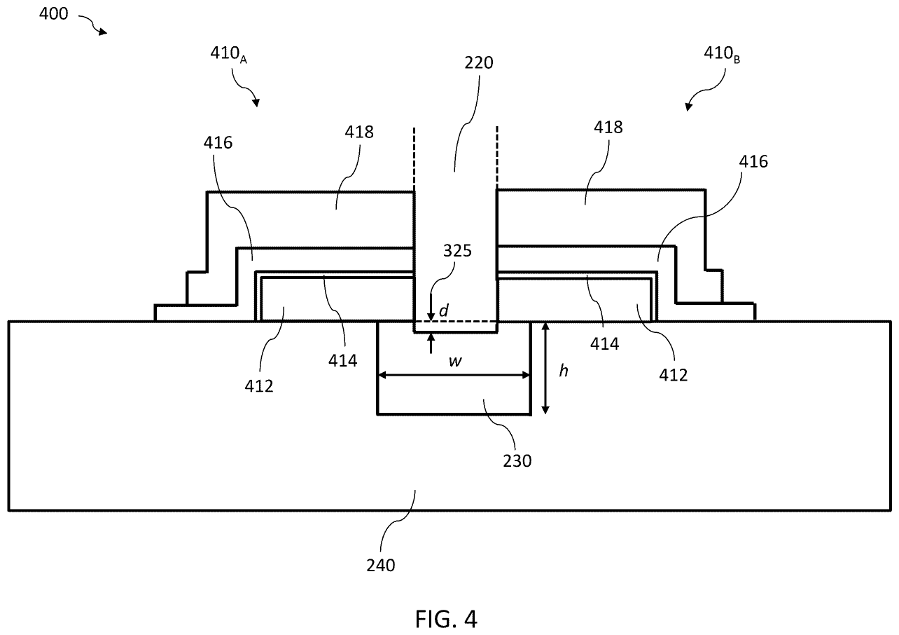

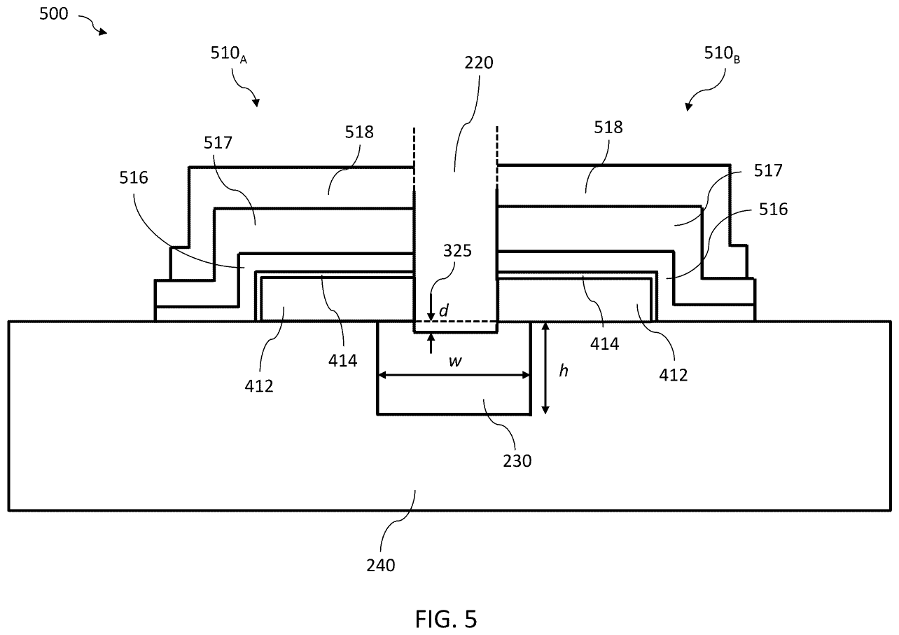

The top surface 231 of the optical waveguide 230 may be at least in part in a same horizontal plane as the top surface 241 of the substrate 240. As discussed elsewhere herein, due to the fabrication of the apparatus, for example by focused ion beam milling, a portion of the top surface 231 optical waveguide 230 below the gap 220 and portions of the top surface 241 of the substrate 240 between the stack assemblies can have a predefined (e.g., overmilling) depth (e.g., 425 with reference to FIGS. 4 and 5) and therefore, this top surface 231 may at least in part lie below the horizontal plane of top surface 241 (i.e., below non-overmilled portions of the substrate external to the gap) of the substrate 240. In other words, the gap may extend into the optical waveguide and the substrate below the horizontal plane a predefined depth (e.g., about 20 nm due to overmilling during fabrication).

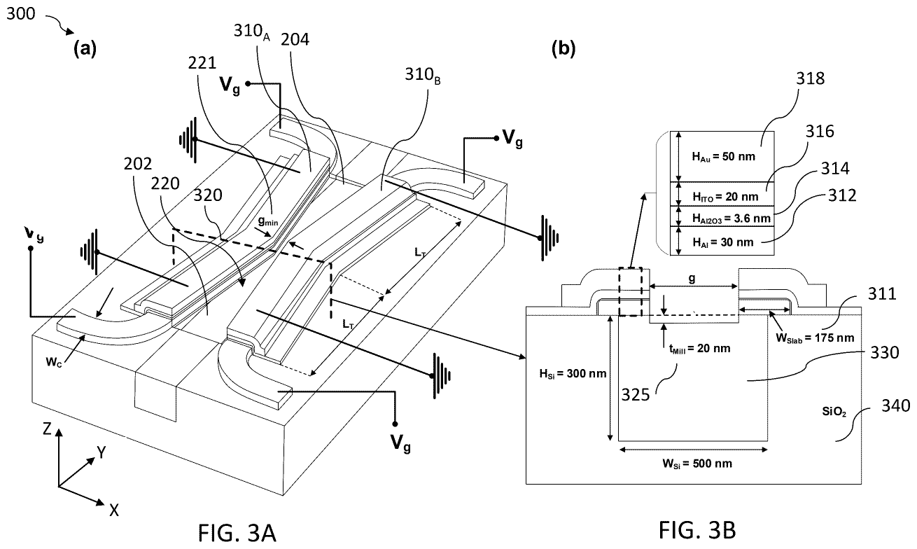

In embodiments, each of the first and second stack assemblies is continuous. An electrical signal, defined at least by a voltage, applied to the anode layer of both stack assemblies is therefore applied to the whole structure of the stack assemblies (e.g., in comparison to being applied only to an active portion of the device in FIG. 1.) Such electrical signals can be applied, for example, at the four corners of the structure (see FIG. 3A) in a single-ended manner, in which a single signal is applied to both stack assemblies with respect to ground, or in a differential manner, in which a different signal is applied to each of the two stack assemblies. In contrast with the design of FIG. 1, and as mentioned above, embodiments of the present disclosure avoid the air slits and instead use a more streamlined structure that allows uniform voltage application across the entire device.

In an embodiment, the first and the second tapered portions of the stack assemblies may, although not necessarily, mirror each other, having the same taper angle and portion length. Thus, the modulator may or may not be symmetric about an axis passing through and parallel to the central region. Each of the first and the second tapered portions may be designed independently or cooperatively, for example using CSS and SPC modeling referenced herein.

In some embodiments, the first and the second stack assemblies have a substantially same width (e.g., within fabrication tolerances). In some embodiments, such widths of the stack assemblies may be constant. In some embodiments, the first and the second stack assemblies may have non-constant widths. In embodiments, stack assemblies are made of a bottom (i.e., on top of the top surface (e.g., 241) of the substrate and top surface (e.g., 230) of the waveguide) anode layer, an insulating coating disposed on top of the anode layer, at least one inorganic modulation material layers disposed on the insulating coating, and an upper cathode layer on top of at least one inorganic modulation material layers (i.e., on top of an uppermost of these layers is two or more layers are present).

Embodiments of the present disclosure provide for a modulator structure which comprises, consists, or consists essentially of two active back-to-back mode conversion tapers of length L_{T} integrally connected to each other at the central region defined at least in part by a narrowest region of the gap, each taper composed of respective portions of the pair of MOS-MIM stacks strategically positioned on top of a planarized (e.g., Si) waveguide, as depicted in FIGS. 2A-6.

A particular embodiment is now described in more detail, with respect to FIG. 3A. The modulator apparatus 300 operating free-space wavelength is selected as 1550 nm. The apparatus 300 includes the first and second stack assemblies 310A, 310B, respectively, separated by a gap 220 having a variable width along the first axial direction, progressively narrowing or converging in a converging region 202 of the gap 220, toward a narrowest region (which may have substantially zero width) having the width 221 of the gap, and then progressively widening or diverging, in a diverging region 204 of the gap 220, away from the narrowest region.

FIG. 3B shows a detailed cross-sectional view of the modulator of FIG. 3A over the area bounded by the black dotted rectangle 320, identifying each layer's dimensions and material for improved clarity. In this example, the apparatus 300 includes a SiO₂ substrate 340, and a Si optical waveguide 330 having a width of about 500 nm, according to an example implementation, and a height of about 300 nm, according to an example implementation. The material stack may be designed using standard wafer fabrication techniques, with a gap 220 of width g between the stack assemblies, defined for example using focused ion beam (FIB) milling. To accommodate for fabrication deviations, a predefined over-milling depth 325 into the Si of, for example, t_{Mill}=20 nm may be included in modelling.

The bottom metal of the stack assemblies 310A, 310B is selected as a 30 nm thick layer of Al (312) having a width of about 175 nm and a height of about 30 nm, according to an example implementation, upon which a 3.6 nm thick insulating coating 314, such as alumina (Al₂O₃, 314), is assumed present, and more specifically on a top surface and an external surface of the anode layer 312, according to an example implementation.

The stack assemblies 310A, 310B, include a 20 nm thick ITO inorganic modulation material layer 316 disposed on the insulating coating 314, and more specifically on a top surface and an external surface of the insulating coating 314, according to an example implementation. The inorganic layer 316 may also extend from the external surface of the insulating coating 314 onto the substrate 340, and therefore may be also disposed on at least a portion of the top surface of the substrate 340 adjacent the inorganic layer disposed on the external surface of the insulating coating 314, as illustrated.

The stack assemblies 310A, 310B, include an upper Au (i.e., gold) cathode layer 318 on top of the inorganic layer 316, having a thickness of about 50 nm, and more specifically on a top surface and at least partially on an external surface of the inorganic layer 316, as illustrated, according to an example implementation.

Thicknesses (i.e., heights), widths (e.g., stack assembly width 311 that may be 175 nm, for example) and selected materials of the layers 312, 314, 316, 318 can be varied or tuned as appropriate.

The bottom Al layer 312 acts as the anode, whereas the top Au layer 318 forms the cathode, creating a simple and effective electrical driving scheme. Thus, the stack assemblies 310A, 310B operate as MOS capacitors formed by the bottom metal layer (Al), the oxide layer (Al₂O₃), and the ITO layer acting as the semiconductor.

Although Al exhibits higher optical absorption than Au, it provides significant fabrication advantages. Specifically, a high quality Al₂O₃ layer 314 can be readily created on the surface of Al by thermal oxidation, avoiding the challenges with deposition, such as inconsistent film quality and island formation. The low permittivity of Al₂O₃ (9.3) compared to, e.g., HfO₂ (25), ensures that the capacitance per unit length of the modulator is manageable.

For the one or more inorganic layers (e.g. 316), use of an electro-optic material offering strong index modulation and compatibility with silicon photonics represents a desirable choice for plasmonic modulator design. One such material is a ternary composition of indium, tin and oxygen, referred to herein as ITO, which recently has shown potential in a number of photonic devices including optical phased arrays and a variety of modulators. The strong charge density modulation in a MOS structure of the stack assemblies enables the epsilon-near-zero (ENZ) regime to be accessed under strong accumulation, producing a very large refractive index modulation at telecommunication wavelengths. The strong refractive index modulation of ITO in the accumulation region can be combined with the strong light confinement produced by plasmonic waveguides, leading to deep optical modulation over a large electrical bandwidth in a compact footprint.

FIG. 4 shows a schematic illustration of a cross-sectional view of an optical modulation apparatus 400 (which may be similar to or the same as the apparatus 200 of FIGS. 2A-2B or the apparatus 300 of FIGS. 3A-3B), according to an example implementation. The apparatus 400 includes two stack assemblies 410A, 410B, separated by the gap 220, and disposed on the top surface of the substrate 240 and at least partially on the top surface of the waveguide 230.

The stack assemblies 410A, 410B, include an anode layer 412, and insulating coating 414 disposed on top of the anode layer, and more specifically on a top surface and an external surface of the anode layer 412, according to an example implementation.

The stack assemblies 410A, 410B, include an inorganic modulation material layer 416 disposed on the insulating coating 414, and more specifically on a top surface and an external surface of the insulating coating 414, according to an example implementation. The inorganic layer 416 extends from the external surface of the insulating coating 414 onto the substrate 240, and therefore is also disposed on at least a portion of the top surface of the substrate 240 adjacent the inorganic layer disposed on the external surface of the insulating coating 414, as illustrated.

The stack assemblies 410A, 410B, include an upper cathode layer 418 on top of the inorganic layer 416, and more specifically on a top surface, on an external surface of the inorganic layer 416, and partially extending onto the extending portion of the inorganic layer 416 that extends onto the substrate 240, as illustrated, according to an example implementation.

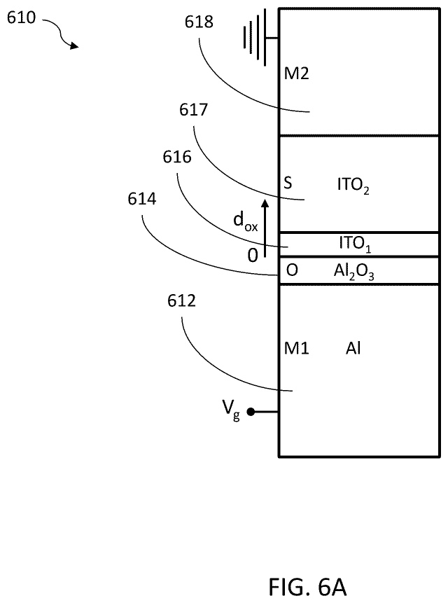

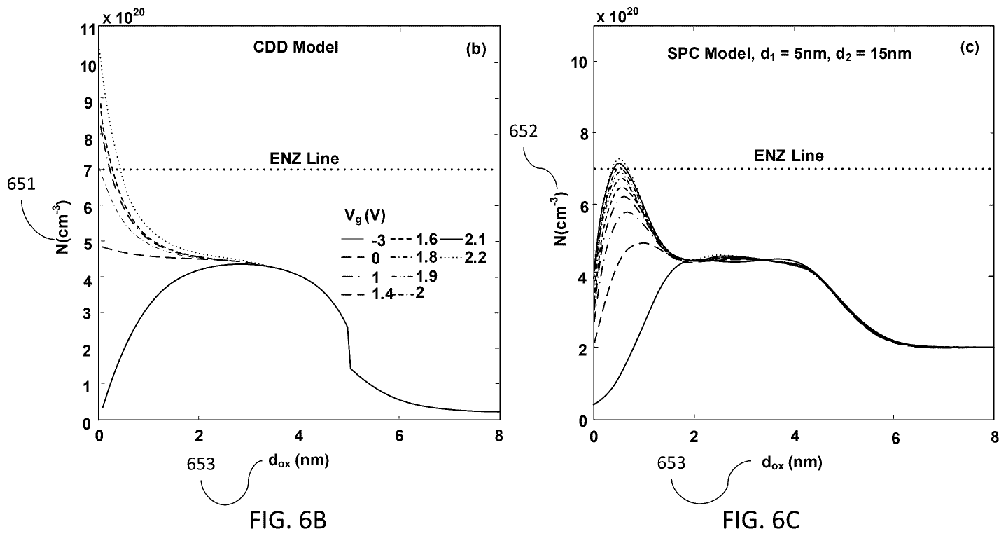

In embodiments, the inorganic layer (e.g., 316 of FIG. 3B, 416 of FIG. 4, cooperatively 516 and 517 of FIG. 5, cooperatively 616 and 617 of FIG. 6A) includes at least one inorganic modulation material layers.

FIG. 5 shows a schematic illustration of a cross-sectional view of an optical modulation apparatus 500, according to an example implementation. The apparatus 500 includes two stack assemblies 510A, 510B, separated by the gap 220, and disposed on the top surface of the substrate 240 and at least partially on the top surface of the waveguide 230. The stack assemblies 510A, 510B, include an anode layer 412 and insulating coating 414, substantially as described with reference to FIG. 4.

The stack assemblies 510A, 510B, include two inorganic modulation material layers 516, 517. The first inorganic layer 516 is disposed on the insulating coating 414, and more specifically on a top surface and an external surface of the insulating coating 414, according to an example implementation. The first inorganic layer 516 may extend from the external surface of the insulating coating 414 onto the substrate 240, and therefore may also be disposed on at least a portion of the top surface of the substrate 240 adjacent the first inorganic layer disposed on the external surface of the insulating coating 414, as illustrated.

The second inorganic layer 517 is disposed on the first inorganic layer 516, and more specifically on a top surface and an external surface of the first inorganic layer 516, according to an example implementation. The second inorganic layer 517 may substantially align and cover the first inorganic layer 516, as illustrated.

Alternatively to two inorganic layers, embodiments may include three or more inorganic layers, or one or more inorganic layers which vary gradually or continuously with respect to certain characteristics thereof, the variation being with distance into the organic layer from the top or bottom surface thereof.

The stack assemblies 510A, 510B, include an upper cathode layer 518 on top of the second inorganic layer 517, and more specifically on a top surface, on an external surface of the second inorganic layer 517, and partially extending onto the extending portion of the second inorganic layer 517 that extends onto the first inorganic layer 516, as illustrated, according to an example implementation.

The components of the apparatus, such as the apparatus 400 of FIG. 4 and apparatus 500 of FIG. 5, are illustrated as having substantially rectangular cross-sections, without limitation. In some implementations, some regions and layer or coating boundaries of cross-sections may include angled cross-sections, curved cross-sections (e.g. as shown in FIGS. 3A and 3B), non-uniform cross-sections, or a combination thereof.

FIG. 6A shows a schematic illustration of a cross-section layers of the stack assemblies 610 having two inorganic layers, such as stack assemblies 510A, 510B of FIG. 5, according to an example implementation. The stack assemblies 610 include a bottom anode layer 612 made of Al, an insulating coating 614 made of Al₂O₃ disposed on top of the bottom anode layer 612, a first inorganic layer 616 made of a first ITO disposed on top of the insulating layer 614, a second inorganic layer 617 made of a second ITO disposed on top of the first inorganic layer 616, and a top cathode layer 618 disposed on top of the second inorganic layer 617. Utilizing two layers of ITO may reduce the amount of drive voltage for modulation. However, the modulator can be configured with either a single layer of ITO or multiple layers of ITO.

Embodiments of the present disclosure can be provided without a passivation layer, e.g. a 20 nm thick oxide passivation layer on top of the device referenced in FIG. 1, further simplifying the structure.

Embodiments of the present disclosure use a metal, such as aluminum (Al) as the bottom electrode, despite its higher optical absorption compared to gold (Au). Aluminum potentially offers fabrication advantages, such as the ease of creating a reliable aluminum oxide (Al₂O₃) insulating coating, which facilitates a more uniform insulating layer and reduces the capacitance per unit length of the modulator. The entire bottom Al layer may act as the anode with the voltage source connected.

Embodiments of the present disclosure provide a top cathode layer, which can be metal such as gold, which is grounded, potentially creating a simplified and effective electrical driving scheme.

Embodiments of the present disclosure provide for an anode layer disposed close to the substrate, followed by an insulating coating on top of the anode layer, followed by at least one inorganic material layers, followed by a cathode layer. In comparison to design of FIG. 1, where the cathode layer is closest to the substrate, embodiments of the present disclosure provide that the MOS capacitor, formed by the bottom anode layer (e.g., metal such as aluminum), the insulating coating (e.g., oxide layer such as AL₂O₃), and the inorganic modulation material (e.g., ITO) layers (i.e., one or more) covering the top and external surfaces (e.g., sidewalls) of the insulting coating, can be efficiently driven by applying voltage. This may enhance the modulation effect both horizontally and vertically within the inorganic modulation material (e.g., ITO) layers.

Embodiments of the present disclosure provide a high-speed plasmonic modulator. The modulator includes stack assemblies that may comprise or consist of an Al—Al₂O₃-ITO stack integrated as a MOS structure within the MIM configuration. Applying voltage across this stack assemblies perturbs the carrier density in the ITO layer, significantly impacting the optical properties of the modulator by dynamically altering the complex refractive index of ITO.

Embodiments of the present disclosure were assessed using the Classical Drift Diffusion (CDD) model and the Schrödinger-Poisson Coupling (SPC) model. The SPC model was used to complement the CDD model in capturing effects due to quantization and is considered to be fundamentally more accurate for modeling of effects on structures that include at least one dimension of a size comparable to an operating wavelength.

One possible advantage of including more than one inorganic layer is to reduce the drive voltage required to reach the ENZ point. A bilayer ITO structure, such as described herein with reference to FIGS. 5 and 6, can be utilized instead of a single-layer ITO. In an illustrative example embodiment, the first (lower) layer (e.g., 616 of FIG. 6) has a higher carrier density of, for example about 4.5×10²⁰ cm⁻³, while the second (upper) layer (e.g., 617 of FIG. 6) has a lower carrier density of, for example about 2×10²⁰ cm⁻³. In one example implementation, the thicknesses of the first and second layers may be 5 nm and 15 nm, respectively. This bilayer configuration facilitates achieving the ENZ point at lower voltages, as the increased carrier density in the first layer facilitates this transition, while the reduced carrier density in the second layer decreases the overall loss in the ITO and, consequently, in the entire structure.

FIGS. 6B and 6C schematically illustrate the carrier density profile within the ITO versus the distance 653 from the oxide-ITO interface at various gate voltages, obtained using the CDD model (651 in FIG. 6B) and the SPC model (652 in FIG. 6C), respectively. FIGS. 6B and 6C demonstrate a significant reduction in the drive voltage required to reach the ENZ point compared to a single-layer ITO. Notably, the SPC predicts that the ENZ point is reached at about 2.0V, which is about 0.6V lower than that of the single-layer ITO.

In comparison with prior art attempts which use organic materials, embodiments of the present disclosure provide a different approach and use non-organic materials to address the reliably issue of organic materials, while maintaining and potentially improving the compactness and high-speed features of plasmonic modulators.

While various embodiments as described in detail herein utilize certain conductive metals (e.g., aluminum), specific insulator (e.g., Al₂O₃) and inorganic materials (e.g., ITO) on top of a Silicon waveguide, other conductive, insulator, inorganic materials on top of either silicon or silicon nitride waveguide can be used in other embodiments. It is possible to use variations of this design for an 850 nm band, 1310 nm band, and 1550 nm band apparatus, and the apparatus may be configured to modulate the optical signal having a wavelength between about 850 nm and about 1550 nm.

A scenario in which embodiments of the present disclosure can be applied is the design of telecommunication optical modulator. In a non-limiting example, the apparatus could be implementable for application utilizing both C-band (1550 nm range) for metro or long-haul optical transmission or O-band (1310 nm range) for computing, machine-learning (ML)/AI or Datacenter Interconnectivity (DCI). The illustrations and configurations as described above may pertain in particular to a C-band design. The design is an ITO based plasmonic modulator where the carrier density is modulated in stack assemblies that include the MOS structures backed by a bottom anode layer (e.g., metal film), which collectively forms a vertical and horizontal plasmonic waveguide. This allows the field to be confined strongly in the thin oxide-ITO region, producing a strong overlap between the modal field and the perturbed ITO layer, resulting in a compact and efficient modulator. The compactness enables the capacitances to be very small, potentially leading to a very high electrical bandwidth. The pair of coupled stack assemblies include a central region, defined elsewhere herein, where the width of the gap therebetween is at least narrowest. Such central region operates with coupled plasmonic modes. A modulating region of the apparatus includes but is not necessarily limited to the central region. The modulating region may include the central region as well as the entirety of the two tapered regions, or at least parts of the two tapered regions. The modulating region, as referred to herein, is generally defined as a region of the stack assemblies where one or more (e.g., target) propagating modes transmitted by the optical waveguide disposed in the substrate couple with or are affected by the stack assemblies. Input and output taper sections (i.e., the first and the second tapered portions of the stack assemblies) are designed for efficient excitation of the relevant mode of the central region of the stack assemblies by the fundamental TE or TM mode of an underlying (e.g., Si) waveguide.

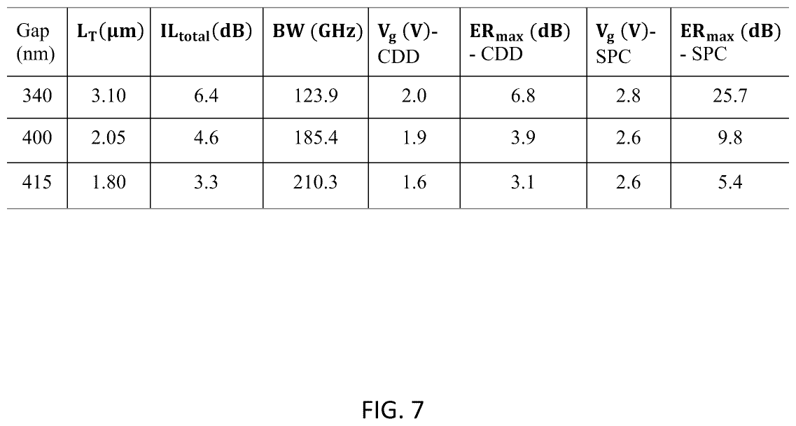

Embodiments described for example with respect to FIGS. 2A-6 may be applied to the design of optical modulators operating in C-band (1550 nm) for many classes of designs depending on the requirements on bandwidth, insertion loss and extinction ratio. As shown in FIG. 7, various design parameters lead to different performance (e.g., in terms of Insertion Loss (IL), Bandwidth (BW), Extinction Ratio (ER), or a combination thereof) that can be tailored for the target application.

As described above, the high-speed plasmonic modulator of embodiments can comprise or consist of an Al—Al₂O₃-ITO-Au stack assemblies, comprising a MOS structure within the MIM configuration. Applying voltage across the stack assemblies perturbs the carrier density in the ITO layer, inducing either depletion or accumulation depending on the voltage polarity. These features may significantly impact the optical properties of the modulator by dynamically altering the complex refractive index of ITO.

In order to optimize the architecture of the optical modulation apparatus for a particular optical signal wavelength, a particular apparatus size requirement, a particular optical signal modulation (e.g., of a particular one or more optical signal mode), or a combination thereof, modeling tools, such as a Classical Drift-Diffusion (CDD) model and a Schrödinger-Poisson Coupling (SPC) model can be used to simulate the perturbed carrier density within the ITO layer. The SPC modeling typically offers a more detailed and precise depiction of electro-optical interactions within an apparatus being modelled compared to the CDD modeling. Both the CDD and the SPC modeling may be implemented using a suitable modeling software, such as COMSOL Multiphysics™, for example.

When using CDD modeling, given that the perturbed carrier density varies with distance from the oxide-ITO interface (i.e., into the ITO layer e.g., normal to and away from the oxide-ITO interface), a one-dimensional (1D) CDD model may be employed, allowing for an estimation of the perturbed carrier density.

The SPC modelling can be used for apparatuses having a size of one or more part or component comparable to the operating wavelength (e.g., 1550 nm), such as various embodiments of the optical modulation apparatus disclosed herein, where quantization effects such as confinement, compressibility, and tunneling significantly influence the apparatus characteristics, such as optical signal propagation. The SPC modeling may, for example, be used in conjunction with the CDD modeling to improve modeling accuracy by using an initial potential distribution and carrier density profile derived from the CDD model.

In a non-limiting example, the perturbed carrier density within the ITO layer at various voltages may be simulated using simulation features of the COMSOL Multiphysics™ software. For the CDD model, the Semiconductor Physics interface from the Semiconductor Module along with the Semiconductor Equilibrium study may be used. For the SPC model, the Schrödinger Equation and Electrostatic Physics interfaces under the Semiconductor Module may be used. These models may be integrated using the Schrödinger-Poisson Coupling physics feature of the COMSOL Multiphysics™ software.

In one example simulation, the thickness and the work function of the Al may be set to 30 nm and 4.1 eV, respectively. The Al₂O₃ layer may be specified with a thickness of 3.6 nm and a static relative permittivity of 9.3. For the ITO layer, the thickness may be set to 20 nm, setting the bulk doping concentration (N_{b}) to 2.65×10²⁰ (cm⁻³); the bandgap energy (E_{g}) to 2.8 eV; the effective mass of the electrons to 0.35 mₑ where the mₑ is the free electron mass; and the electron affinity (χₛ) and static relative permittivity (εₛ) to 4.8 eV and 9.1, respectively. Since the Fermi energy of Al is typically higher than ITO, short-circuiting the terminals results in electrons flow from the Al layer to the ITO layer to align the Fermi levels, resulting in the creation of an accumulation region within the ITO layer at zero applied voltage.

To analyze the impact of voltage on the optical response of the modulator, the spatially-dependent permittivity in the perturbed region of ITO at various voltages was calculated. The carrier density distributions obtained from the CDD and SPC models may be used, for example in the Drude model to compute the corresponding permittivity distributions, using the following equation applied at a free space operating wavelength of 1550 nm:

$$ε ( {d}_{ox} , ω ) = {ε}_{∞} - ( \frac{N ( {d}_{ox} ) {ω}_{b , p}^{2}}{{N}_{b}} ) / ( {ω}^{2} + i Γω ) \qquad ( 1 )$$

where, ε_{∞}=3.92 represents the high-frequency relative permittivity, N_{b}=2.65×10²⁰ cm⁻³ is the unperturbed carrier density in ITO, ω_{b,p}=1.55×10¹⁵ rad/s denotes the bulk plasma frequency, and Γ=4.4×10¹³ rad/s is the damping frequency. These parameters were derived by fitting the measured bulk permittivity of ITO to Eq. 1. N(dₒₓ) represents the spatially-dependent carrier density profile of ITO, as determined from the CDD and SPC models.

To understand the modal transformation of the modulator under varying drive voltage and design conditions, the frequency-domain vector wave equations, derived from Maxwell's equations (Eq. 2 and 3 below), were solved subject to specific boundary conditions. These equations are useful for capturing the detailed behavior of the electromagnetic fields within the modulator structure:

$$∇ \times ( \frac{1}{{μ}_{r}} ∇ \times E ( r ) ) - {k}_{0}^{2} {ε}_{r} ( r ) E ( r ) = 0 \qquad ( 2 )$$

$$∇ \times ( \frac{1}{{ε}_{r} ( r )} ∇ \times H ( r ) ) - {k}_{0}^{2} {μ}_{r} H ( r ) = 0 \qquad ( 3 )$$

Here, μᵣ=1 is the relative permeability, and E and H represents the electric and magnetic field vectors, respectively. εᵣ(r) is the voltage-modulated spatially-dependent relative permittivity, and k₀ is the free-space wavevector.

For the optical simulations, the Waveoptics module in COMSOL Multiphysics™ was employed. To compute the modes in the modulator cross-section depicted in FIG. 3B under various design and operating conditions, the 2D Electromagnetic Waves (frequency domain) interface was used.

For comprehensive 3D simulations of the entire example modulator shown in FIG. 3A, and to analyzing adiabatic mode conversion in the tapers at different voltages, the Beam Envelope method in COMSOL Multiphysics™ was employed.

According to embodiments of the optical modulation apparatus design, the tapered portions of the stack assemblies are important to provide for the efficient and selective transformation of modes between the (e.g., Si) waveguide and the stack assemblies. Without carefully engineered tapers, the excited modes may face significant losses due to power being diverted into non-targeted modes, including radiative modes. Inadequately designed tapers also contribute to low extinction ratios as unmodulated modes propagate forward and interfere with the modes emerging from the tapered portions. Therefore, optimal performance depends on the successful transformation of the mode at the input into the stack assemblies through the first tapered portion, and effectively returning the modulated modes back to the output Si waveguide via the second tapered portion.

In optimizing the performance of integrated plasmonic modulators, the design of the taper (i.e., first and second tapered portions of the stack assemblies) plays a role in the efficient and selective transformation of modes between the optical waveguide and the stack assemblies. The dimensions and geometric configuration of the tapered portions, specifically the length and angle (i.e., angle Y 236 illustrated in FIGS. 2A-2B), are parameters that, at least in part, determine how effectively the mode is transformed (e.g., minimal losses and undesired mode coupling).

Modeling methods, such as those reference elsewhere herein, may be used for the analysis of modal evolution and transformation for various tapered portion lengths to provide an understanding of the intrinsic performance of the modulator under flat band conditions. To analyze the effects of the voltage on the operation and performance of the apparatus, field distributions along the modulator at three different gate voltages, computed using a 3D model of the structure, were examined. The electric fields are normalized at the input and maintain their relative magnitude along the length of the structure.

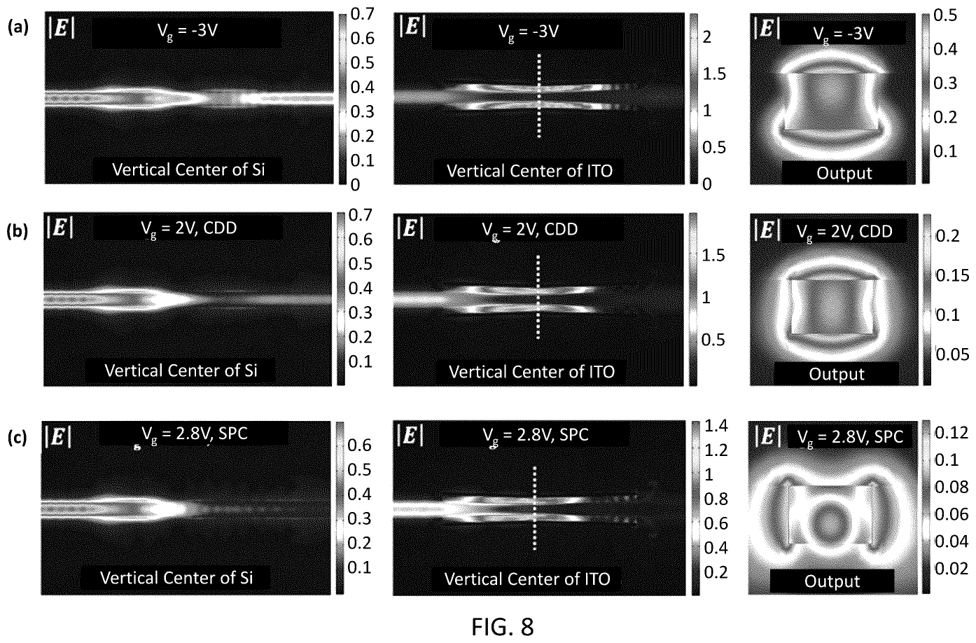

FIG. 8(a) shows the distribution of the electric field magnitude at the gate voltage of −3 V, representing operation under strong depletion corresponding to the low insertion loss (on) state of the modulator. It is noted that the field distribution is almost identical for both CDD and SPC models, given that the models defer little in depletion. Also plotted in FIGS. 8(b) and 8(c) are the field distributions at a gate voltage inducing strong accumulation and just beyond the ENZ voltages, 2 V for the CDD model and 2.8 V for the SPC model, respectively, where the ER reaches the maximum values predicted by these models. These voltages correspond to the high insertion loss (off) state of the modulator. The left, middle and right panels show the distribution of the electric field magnitude along the longitudinal vertical center of the silicon waveguide, along the longitudinal vertical center of the ITO, and over the cross-section at the output, respectively.

Comparing the field distribution along the Si waveguide in FIG. 8(a) to those under accumulation in FIGS. 8(b) and 8(c) shows the depth of the extinction predicted by the models due to the increased attenuation (lm(n_{eff})) of the stack assemblies—in both cases, a significantly attenuated field is noted in the output Si waveguide. Notably, the extinction is more pronounced using the SPC model. Also, it is noted that the maximum field in the stack assemblies shifts toward the input at these voltages for both models, illustrating how the applied voltage impacts mode transformation and confinement within the modulator.

It is also noted that the output field distribution under accumulation differs from that of the input TM₀ mode, especially for the SPC model. This difference occurs because when the TM₀ mode of the silicon waveguide enters and progresses through the tapers of the modulator, it excites (slightly) other unwanted modes. Despite carrying a small fraction of the total power, these unwanted modes propagate through the modulator unaffected by the applied voltage. Consequently, the output field comprises the TM₀ mode which was highly attenuated by the applied voltage, and the residual unwanted (and unmodulated) modes. The unwanted modes are weakly bound and can be eliminated from the output by adding S-bend Si waveguides to the end of the modulator, as discussed relative to the flat band voltage case. It is noted that while these unwanted modes are also present in the CDD model calculations, their contribution to the overall field distribution is smaller than that of the TM₀ mode because the former is less attenuated.

In embodiment, the apparatus may be configured for propagation and modulation of a selected one or more (e.g., TE, TM) mode of the optical signal. Such configuring may involve selecting, e.g. with the air of modeling tools such as CDD and SPC models referenced herein, one or more of: one or more material for the stack assemblies, the optical waveguide, the substrate, or a combination thereof; dimensions of the layers of the stack assemblies; dimensions of the gap and the width of the narrowest region of the gap, design of tapered portions of the stack assemblies (e.g. length, width, angle); structure of the layers of the stack assemblies (e.g., whether some layers extend onto the external wall of a layer beneath, whether some layers extend onto the substrate, etc.); and addition of a bent section to the optical waveguide.

The electrical bandwidth of a modulator is another important parameter as it determines the bit-rate at which data can be impressed into the optical carrier. The apparatus being very short (e.g., about 6 μm from input to output end of the stack assemblies) can be considered as a lumped element, so its 3-dB bandwidth is simply that of the MOS capacitor driven into accumulation embedded into parasitic and load resistances.

In an example, implementation, a modulator having tapered portions of length L_{T}=3.1 μm each, the 3-dB bandwidth is determined, using modeling, to be 124 GHz, predicting a high-frequency operation of such optical modulation apparatus design.

In some embodiments, for a given gap, and particularly in implementations where the size of the tapered portions is small (e.g. short), some part of the TM₀ mode may couple to undesired modes while propagating along the modulator. To remove or reduce these undesirable modes that are weakly bounded, S-bend (e.g., Si) waveguides may be added to the output end of the modulator. For example, four such S-bends can be coupled in series with the modulator output end.

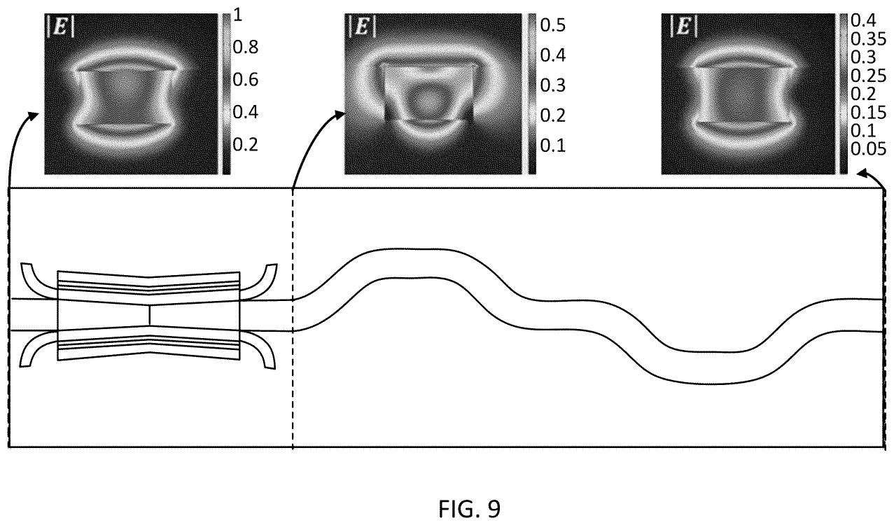

FIG. 9 shows the top view of the modulator, according to example implementation, that includes S-bend silicon waveguides, and the electric field distribution of the TM₀ mode of the Si waveguide at the input port (left panel), output port (middle panel), and end of the S-bend Si waveguides (right panel), obtained from simulation. The simulation was done for the flat band voltage case, and the length of the taper, and radius of the S-bend waveguides were taken as L_{T}=1 μm and r_{S}=2 μm, respectively. As shown, the field distribution at the output port (middle panel) significantly differs from the input one; however, at the end of the S-bend waveguides, it closely resembles the input one, demonstrating the effectiveness of this approach for stripping weakly bound higher order modes.

In embodiments, the apparatus is configured for propagation of at least one target mode of the optical signal. The optical waveguide may include a bent section having at least one S-shaped bend. Such bent section is longitudinally integral with and following the linear section of the optical waveguide, and is configured to limit propagation of a one or more mode other than the at least one target mode of the optical signal.

Since in some cases the ER obtained with above-described embodiments was more than 25 dB, which is quite large, in this section, in some implementations, a further optimization of the modulator performance may be obtained by boosting the bandwidth and reducing the insertion loss (IL), for example by sacrificing some of the ER. To achieve this, the angle of the tapered portions can be maintained, but the modulator length can be reduced by increasing the width of the gap g between the stack assemblies. This reduction in length decreases the area of the stack assemblies, which in turn reduces the capacitance. Since the bandwidth is inversely proportional to capacitance, the bandwidth increases. Additionally, the shorter modulator length reduces the insertion loss.

In this disclosure, a design of a high-speed plasmonic electro-optic modulator apparatus with a high extinction ratio is described. An embodiment operating at a free-space operating wavelength of 1550 nm has been illustrated. These modulators address one or more challenges in existing designs through a combination of innovative structural and material modifications. The apparatus, comprised of a pair of stack assemblies that include coupled MOS-MIM stacks integrated on a planarized (e.g., Si) waveguide, benefits from reduced structural complexity, which enhances fabrication feasibility and device performance by limiting or minimizing parasitic effects. The coupled stack assemblies include tapered portions that act as tapers, in an illustrative embodiment adiabatically transforming the TM₀ mode of the input waveguide to the symmetric plasmonic TM mode in the central region of the stack assemblies, and re-transforming it to the TM₀ mode of the output waveguide. In some embodiments, the apparatus is operable by receiving the optical signal at the optical waveguide and applying a voltage in the range of about 1.6V to about 2.8V to the anode layer. By applying a voltage, epsilon-near-zero (ENZ) state is induced in the perturbed region of the inorganic layer (e.g., ITO), of (e.g., Al—Al₂O₃-ITO) MOS structures embedded in the MIM structure of the stack assemblies, by driving the latter into strong accumulation.

The CDD) and the SPC) modeling methods can be used to obtain voltage-dependent perturbed carrier density inside the inorganic layer and determine the electro-optical response of the apparatus. These models predict similar results in the depletion region but differ significantly in the accumulation regime. Specifically, in strong accumulation, the SPC model predicts two ENZ points for the Re(ε) of the perturbed region of the ITO, while the CDD model predicts a single ENZ point, resulting in higher changes in the optical response of the device predicted by the SPC model. For example, ΔRe (n_{eff}) and ΔIm (n_{eff}) predicted by the SPC model are −0.155 and 0.19 for an applied voltage attaining ENZ, which is ˜2× and ˜4× the corresponding values predicted by the CDD model. These differences highlight the importance of effects due to quantization on optical response of the modulator that are contained within the SPC but not the CDD, which need to be considered for accurately computing the perturbed carrier density within the ITO.

In an example implementation, one optimized linear taper design of length L_{T}=3.1 μm yields a modulator that achieves a 3-dB bandwidth of 124 GHZ, an insertion loss of 6 dB, and an extinction ratio of 26 dB as predicted by the SPC model. The trade-off between bandwidth and insertion loss vs. extinction ratio was also analyzed in detail, resulting in another optimal design that yields a 3-dB bandwidth of 210 GHz and an insertion loss of 3 dB, for a taper length of L_{T}=1.8 μm, but at a lower ER of 5 dB, as predicted by the SPC model. Results offer insights for further optimization, demonstrating the balance between high-speed operation, low insertion loss, and modulation depth. The modulator designs are suitable for high-speed optical interconnects, offering scalable solutions for integrated photonics and optical communications.

Embodiments of the present disclosure can be applied to interconnect solutions for High Performance Computing, Servers, General Processing Unit (GPU) of Machine learning/AI and datacenter switches as well as transceiver design, transponder design, an optical transmitter design, or a combination thereof, for example for metro/long-haul optical networks.

In embodiments, the apparatus as described herein with reference to FIGS. 2A-6, can be used for the design of datacenter and computing modulators operating at 1310 nm for design of pluggable or integrated transceivers. The design parameters to vary to achieve this mode of operation include (but not limited to): dimension of silicon or silicon nitride waveguide, the width of gap g between the stack assemblies (at least 2), length of tapered portions L_{T}, and the dimensions of inorganic (e.g., ITO) materials (e.g., layers thickness, relative thickness of layers when two or more layers are provided, relative ratios of indium tin and oxygen in the ternary composition). Some or all of these parameters can be optimized, for example using modeling as described herein, to achieve a target BW, IL ER, or a combination thereof for the transceiver.

It will be appreciated that, although specific embodiments of the technology have been described herein for purposes of illustration, various modifications may be made without departing from the scope of the technology. The specification and drawings are, accordingly, to be regarded simply as an illustration of the disclosure as defined by the appended claims, and are contemplated to cover any and all modifications, variations, combinations or equivalents that fall within the scope of the present disclosure. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present disclosure may be implemented by using hardware only or by using software and a necessary universal hardware platform. Based on such understandings, the technical solution of the present disclosure may be embodied in the form of a software product. The software product may be stored in a non-volatile or non-transitory storage medium, which can be a compact disk read-only memory (CD-ROM), USB flash disk, or a removable hard disk. The software product may include a number of instructions that enable a computer device (personal computer, server, or network device) to execute the methods provided in the embodiments of the present disclosure. For example, such an execution may correspond to a simulation of the logical operations as described herein. The software product may additionally or alternatively include number of instructions that enable a computer device to execute operations for configuring or programming a digital logic apparatus in accordance with embodiments of the present disclosure.

The word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

The terms “coupled”, “coupling” or “connected” as used herein can have several different meanings depending on the context in which these terms are used. For example, as used herein, the terms coupled, coupling, or connected can indicate that two elements or devices are directly connected to one another or connected to one another through one or more intermediate elements or devices via an electronic element depending on the particular context. The term “and/or” herein when used in association with a list of items means any one or more of the items comprising that list.

Although a combination of features is shown in the illustrated embodiments, not all of them need to be combined to realize the benefits of various embodiments of this disclosure. In other words, a system or method designed according to an embodiment of this disclosure will not necessarily include all features shown in any one of the Figures or all portions schematically shown in the Figures. Moreover, selected features of one example embodiment may be combined with selected features of other example embodiments.

Although the present disclosure has been described with reference to specific features and embodiments thereof, it is evident that various modifications and combinations can be made thereto without departing from the disclosure. The specification and drawings are, accordingly, to be regarded simply as an illustration of the disclosure as defined by the appended claims, and are contemplated to cover any and all modifications, variations, combinations or equivalents that fall within the scope of the present disclosure.

What is claimed is:

1. An optical modulation apparatus comprising:
an optical waveguide disposed in a substrate and configured for guiding an optical signal, a top surface of the optical waveguide being at least in part in a same horizontal plane as a top surface of the substrate, the optical waveguide having a longitudinally linear section;
a first stack assembly longitudinally disposed on the top surface of the substrate and at least partially on the top surface of the longitudinally linear section of the optical waveguide; and
a second stack assembly longitudinally disposed on the top surface of the substrate and at least partially on the top surface of the longitudinally linear section of the optical waveguide, the first and the second stack assemblies being separated by a gap above and longitudinally aligned with the optical waveguide, each stack assembly of the first and the second stack assemblies comprising:
an anode layer;
an insulating coating disposed on top of the anode layer;
at least one inorganic modulation material layers disposed on the insulating coating; and
a cathode layer disposed on top of the at least one inorganic modulation material layers.

2. The apparatus of claim 1, wherein the first and the second stack assemblies cooperatively comprise:
a central region defined at least in part by a narrowest region of the gap;
a first tapered portion integral with the central region and defined by opposing inner walls of the first and the second stack assemblies converging asymptotically along the longitudinal direction towards the central region; and
a second tapered portion integral with the central region and defined by the opposing inner walls of the first and the second stack assemblies diverging along the longitudinal direction away from the central region.

3. The optical modulation apparatus of claim 1, wherein the anode layer is made of aluminum.

4. The optical modulation apparatus of claim 1, wherein the insulating coating is made of aluminum oxide.

5. The optical modulation apparatus of claim 1, wherein each inorganic modulation material layer of the at least one inorganic modulation material layers is made of a respective ternary composition of indium, tin and oxygen.

6. The optical modulation apparatus of claim 1, wherein the gap extends into the optical waveguide and the substrate below the horizontal plane by a predefined depth.

7. The optical modulation apparatus of claim 1, wherein the apparatus is configured for propagation of at least one target mode of the optical signal, the optical waveguide comprises a bent section having at least one S-shaped bend, the bent section longitudinally integral with and following the linear section of the optical waveguide, the bent section configured to limit propagation of a one or more mode other than the at least one target mode of the optical signal.

8. The optical modulation apparatus of claim 2, wherein the first tapered portion and the second tapered portion are linearly tapered at an acute angle in the range of about 2 degrees to about 5 degrees.

9. The optical modulation apparatus of claim 1, wherein the first and the second stack assemblies have a substantially same width.

10. The optical modulation apparatus of claim 1, wherein the insulating coating is disposed on a top surface and an external surface of the anode layer.

11. The optical modulation apparatus of claim 10, wherein the at least one inorganic modulation material layers are disposed on a top surface and an external surface of the insulating coating.

12. The optical modulation apparatus of claim 11, wherein the at least one inorganic modulation material layers are further disposed on at least a portion of the top surface of the substrate adjacent the at least one inorganic modulation material layers disposed on the external surface of the insulating coating.

13. The optical modulation apparatus of claim 11 or 12, wherein the cathode layer is disposed on a top surface and at least partially on an external surface of the at least one inorganic modulation material layers.

14. The optical modulation apparatus of claim 2, wherein the narrowest region of the gap has a width in the range of about 200 nm to about 500 nm.

15. The optical modulation apparatus of claim 2, wherein an input end of the first tapered portion of the gap has a width in the range of about 400 nm to about 1000 nm and an output end of the second tapered portion of the gap has a width in the range of about 400 nm to about 1000 nm.

16. The optical modulation apparatus of claim 1, wherein the apparatus is operable by receiving the optical signal at the optical waveguide and applying a voltage in the range of about 1.6V to about 2.8V to the anode layer.

17. The optical modulation apparatus of claim 1, wherein the apparatus is configured to modulate the optical signal having a wavelength between about 850 nm and about 1550 nm.

18. An optical transceiver comprising the apparatus according to claim 1.

19. A method comprising:
receiving an optical signal at an optical waveguide disposed in a substrate and configured for guiding the optical signal, a top surface of the optical waveguide being at least in part in a same plane as a top surface of the substrate, the optical waveguide having a longitudinally linear section;
applying an electrical signal to a first stack assembly and a second stack assembly,
the first stack assembly longitudinally disposed on the top surface of the substrate and at least partially on the top surface of the longitudinally linear section of the optical waveguide; and
the second stack assembly longitudinally disposed on the top surface of the substrate and at least partially on the top surface of the longitudinally linear section of the optical waveguide, the first and the second stack assemblies being separated by a gap above and longitudinally aligned with the optical waveguide, each stack assembly of the first and the second stack assemblies comprising:
an anode layer;
an insulating coating disposed on top of the anode layer;
at least one inorganic modulation material layers disposed on the insulating coating; and
a cathode layer disposed on top of the at least one inorganic modulation material layers.

20. The method of claim 19, further comprising obtaining a modulated optical signal modulated in accordance with the electrical signal.
